(19) United States
(12) Patent Application Publication
(10) Pub. No.: US 2003/0126612 A1
(43) Pub. Date: Jul. 3, 2003

(54) Data transmission system, data transmitter, and remote control method

(75) Inventors: Takeshi Ikeda, Tokyo (JP); Hiroshi Miyagi, Yokohama-shi (JP)

Correspondence Address: CONNOLLY BOVE LODGE & HUTZ LLP, SUITE 800, 1990 M STREET NW, WASHINGTON, DC, 20036-3425, US

(73) Assignee: Niigata Seimitsu Co., Ltd.

(21) Appl. No.: 10/366,566

(22) Filed: Feb. 14, 2003

Related U.S. Application Data
(63) Continuation-in-part of application No. PCT/JP01/07014, filed on Aug. 14, 2001.

(30) Foreign Application Priority Data
Aug. 14, 2000 (JP) 2000-245480

(51) Int. Cl. H04N 7/173

(52) U.S. Cl. 725/105; 725/111; 725/114; 725/134

(57) ABSTRACT

A two-way CATV system where a center device (1) and a cable modem (8) are connected via a CATV line (7) comprises a hard disc drive (11) for recording TV broadcasting programs transmitted from the center device (1) to the cable modem (8) via the CATV line (7). An e-mail transmitted over the Internet (5) to the center device (1) is transmitted to the cable modem (8) via the CATV line (7). The cable modem (8) analyzes the content of the e-mail to execute the processing specified by this e-mail, so that recording of TV broadcasting programs, download of digital contents, etc. with the CATV can be remotely operated from outside where a user stays with an internet-compatible portable information terminal.

### BACKGROUND OF THE INVENTION

1. Field of the Invention

The present invention relates to a data transmission system, a data transmitter, and a remote control method, and is a preferable system which, for example, transmits and receives digital data using a CATV (cable television) network.

2. Description of the Related Art

In various television broadcasts such as satellite, terrestrial, CATV (cable television) broadcasting, etc. using a BS (broadcast satellite) and a CS (communications satellite), CATV has bidirectional communications capabilities unlike unidirectional television broadcasting.

Using the CATV with the above-mentioned capabilities, a system constantly connected to Internet through a cable modem has already been provided. Additionally, various bidirectional services such as the distribution of music, moving pictures, game software, etc., the video-on-demand service for distributing only user-requested programs, an electronic transaction for broadcast of merchandise information as video for application for purchase of merchandise through a user terminal, etc. have raised worldwide expectations.

To improve the quality of these bidirectional services, using a receiver having a built-in large-capacity storage medium such as a hard disk, etc. has attracted much attention. Using a hard disk, various services can be realized in distributing digital contents such as music, moving pictures, etc. For example, by storing distributed music and moving pictures on a hard disk, desired music and moving pictures can be selected later at any time and quickly played back.

As described above, CATV has bidirectional communications capabilities, and can be constantly connected to Internet. On the other hand, a CATV receiver can be provided with a built-in hard disk, etc. to record television programs, digital contents, etc. received through airwaves or Internet.

In the above-mentioned situations, the user convenience can be much enhanced by distributing recorded television programs, digital contents, etc. through CATV in a remote control system over the Internet from anywhere the user is located. However, there have conventionally been no service systems of remotely controlling the distribution of recorded television programs and digital contents, etc. using the bidirectional capabilities of the CATV from anywhere the user is located.

The present invention has been developed to solve the above-mentioned problems, and aims at improving the user convenience in the bidirectional services of CATV by realizing a remote operation of distributing recorded television programs, digital contents, etc. through CATV from anywhere the user is located.

### SUMMARY OF THE INVENTION

The data transmission system according to the present invention refers to a data transmission system having a center device and one or more data transmitters connected to the center device through a transmission line, including: a data recording medium for accumulating and storing data transmitted from the center device to the data transmitter through the transmission line; and control means for receiving electronic mail, which is including desired instruction contents transmitted to the center device, by the data transmitter through the transmission line, analyzing contents of the electronic mail, and performing a controlling process to perform a process specified by the electronic mail; and a mail server for accumulating and managing electronic mail transmitted to the center device, and the electronic mail can be received by the data transmitter through the transmission line by the data transmitter issuing a mail acquisition request to the mail server using a predetermined tone signal received through a telephone line as a trigger.

The data transmitter according to the present invention refers to a data transmitter connected to a center device through a transmission line, including control means for receiving electronic mail including desired instruction contents transmitted to the center device through the transmission line, and performing a controlling process to accumulate and store data transmitted from the center device through the transmission line in a data recording medium depending on contents of the electronic mail. The electronic mail is received through the transmission line by issuing a mail acquisition request to a mail server using a predetermined tone signal received through a telephone line as a trigger.

The remote control method according to the present invention, for use with a data transmission system having a center device and one or more data transmitters connected to the center device through a transmission line, including: transmitting electronic mail including desired instruction contents to the center device, further transmitting the electronic mail from the center device to the data transmitter through the transmission line, and analyzing contents of the electronic mail received by the data transmitter, thereby performing a process specified by the electronic mail, and making electronic mail transmitted to the center device to be accumulated and managed in a mail server, and the data transmitter issues a mail acquisition request to the mail server using a predetermined tone signal received through a telephone line as a trigger, thereby receiving the electronic mail by the data transmitter through the transmission line.

Since the present invention is configured by the above-mentioned technological means, the electronic mail including desired instruction contents transmitted to the center device is transmitted to the data transmitter from the center device through a transmission line, and the data transmitter interprets the contents of the electronic mail to perform a corresponding process, thereby remotely operating the process performed in the data transmitter. Thus, when a CATV line is used as a transmission line, recording a television program through CATV, the distribution of digital contents, etc. can be remotely operated from anywhere a user is located using an Internet-capable mobile information terminal, thereby successfully improving the convenience of bidirectional CATV services.

### BRIEF DESCRIPTION OF THE DRAWINGS

FIG. 1 shows an example of an entire configuration of the bidirectional CATV system embodying the data transmission system according to the present invention; and

FIG. 2 shows an example of a configuration of the central portion of the cable modem embodying the data transmitter according to the present invention.

### DETAILED DESCRIPTION OF THE PREFERRED EMBODIMENTS

An embodiment of the present invention is described below by referring to the attached drawings.

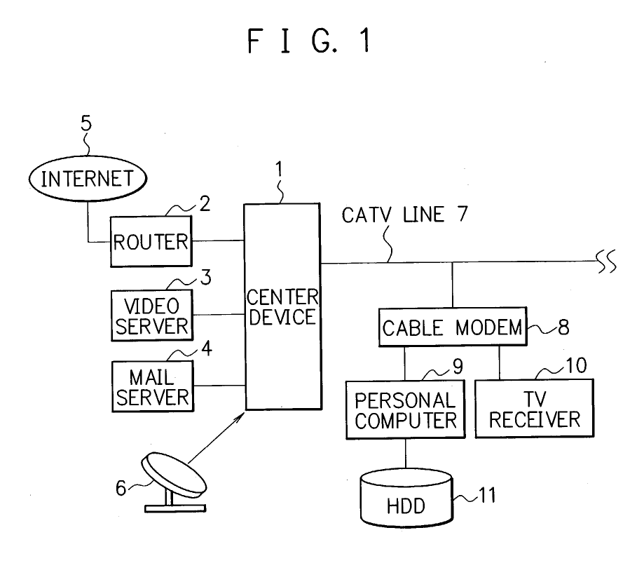

FIG. 1 shows an example of an entire configuration of the bidirectional CATV system embodying the data transmission system according to the present invention.

In FIG. 1, a center device 1 receives various data such as digital contents including music, moving pictures, still pictures, game software, programs, etc., and electronic mail including a command for a remote operation, etc. over the Internet 5 through a router 2. The center device 1 also receives a television program transmitted from a program provider, a program producer, etc. through an antenna group 6. Furthermore, the center device 1 receives a television program from a video server 3 which records a program, etc. produced for a voluntary broadcast by a CATV station. The received digital data is converted into downstream data for CATV, and transmitted to a CATV line 7.

Furthermore, the center device 1 receives from the CATV line 7 the data transmitted as upstream data from the CATV line 7, for example, electronic mail acquisition request data including a command for the above-mentioned remote operation, and reply data for the above-mentioned command, converts the format of the received data and transmits the result to Internet 5.

A mail server 4 accumulates and manages the electronic mail transmitted from through the router 2 over the Internet 5. Then, it retrieves electronic mail addressed to the cable modem 8 from the accumulated and managed electronic mail depending on the electronic mail acquisition request data transmitted from a cable modem 8 through the CATV line 7, and transmits the retrieved mail to the CATV line 7.

The cable modem 8 receives the downstream data from the CATV line 7, and demultiplexes them into video data, audio data, computer data, etc. Then, each piece of the demultiplexed data is appropriately output to a personal computer 9 or a TV receiver 10. The cable modem 8 further converts access request data output from the personal computer 9 to Internet 5, electronic mail acquisition request data generated by the cable modem 8 the above-mentioned reply data into upstream data, and transmits the results to the CATV line 7.

With the above-mentioned configuration, each family subscriber of CATV can enjoy on the TV receiver 10 the video such as a program of a civil broadcasting station (program received by the center device 1 through the antenna group 6) transmitted from the center device 1 through the CATV line 7, a voluntary broadcast program of a CATV station, etc. using the bidirectional CATV-capable cable modem 8. Additionally, a home page of Internet 5 can be inspected by connecting the personal computer 9 to Internet 5 through the CATV line 7.

The personal computer 9 is provided with a hard disk 11 as a built-in or an external device. Thus, the user of the personal computer 9 accesses Internet 5 to download various digital contents such as music, moving pictures, still pictures, game software, a program, etc., and can accumulate them on the hard disk 11. It is also possible to accumulate on the hard disk 11 the video of a program of a civil broadcasting station, a voluntary broadcast program of a CATV station, etc. transmitted from the center device 1.

In the present embodiment, the accumulation of the above-mentioned television programs on the hard disk 11 can not only be performed by issuing an instruction on the personal computer 9, but also be remotely controlled using electronic mail from anywhere the user is located etc. The remotely controlled operations are described below.

When a user instructs a CATV television program to be recorded on the hard disk 11 from anywhere the user is located etc., the user transmits electronic mail specifying the recording of a television program to the personal computer 9 at home using a terminal device which can be connected to Internet 5 from anywhere the user is located, for example, an Internet-capable mobile information terminal such as a mobile telephone, a PHS, a PDA (personal digital assistant), etc. The record instruction can be an instruction to immediately start the recording, or a recording reservation instruction for recording a program in a specified time period. The electronic mail transmitted from a mobile telephone, etc. to Internet 5 is fetched to the center device 1 through the router 2, and accumulated and managed by the mail server 4.

On the other hand, the cable modem 8 periodically or irregularly generates electronic mail acquisition request data, converts the data into upstream data, and transmits the data to the center device 1 through the CATV line 7. Upon receipt of the electronic mail acquisition request data, the center device 1 accesses the mail server 4, and retrieves the electronic mail addressed to the cable modem 8 which has issued an acquisition request. Then, it returns the retrieved electronic mail to the cable modem 8 through the CATV line 7.

Upon receipt of the electronic mail, the cable modem 8 analyzes the instruction contents described in the electronic mail, and extracts a command for the recording. Then, it controls the internal circuit of the cable modem 8 and the personal computer 9 according to the extracted command so that the recording can be performed or reserved on the hard disk 11. When a recording reservation is made, the recording starting time and the recording stop time are specified. If the starting time of the recording is specified by electronic mail, the stop time of the recording is also specified later at any time by electronic mail.

According to the present embodiment, not only a record instruction can be issued in a remote operation, but also a recording status (whether or not a program is being recorded, what is the contents of the recording reservation, the remaining storage capacity of the hard disk 11, etc.) can be confirmed. That is, if a user requests to confirm the current recording reservation from anywhere the user is currently located etc., the user transmits electronic mail specifying the confirmation of the recording status from an Internet-capable mobile telephone, etc. to the personal computer 9 at home.

The electronic mail transmitted from the mobile telephone, etc. to Internet 5 is fetched to the center device 1 through the router 2, and accumulated and managed by the mail server 4. Then, depending on the electronic mail acquisition request data periodically or irregularly transmitted from the cable modem 8 to the center device 1, the electronic mail addressed to the cable modem 8 is retrieved from the mail server 4, returned to the cable modem 8 through the CATV line 7.

Upon receipt of the electronic mail, the cable modem 8 analyzes the instruction contents described in the electronic mail, and extracts a command to confirm the recording status. Then, according to the extracted command, the cable modem 8 controls the internal circuit of the cable modem 8 and the personal computer 9, generates electronic mail describing the recording status, and transmits the mail as reply data of the command to the center device 1 through the CATV line 7. The center device 1 transmits the received electronic mail to the mobile telephone, etc. of the confirmation requester over the Internet 5.

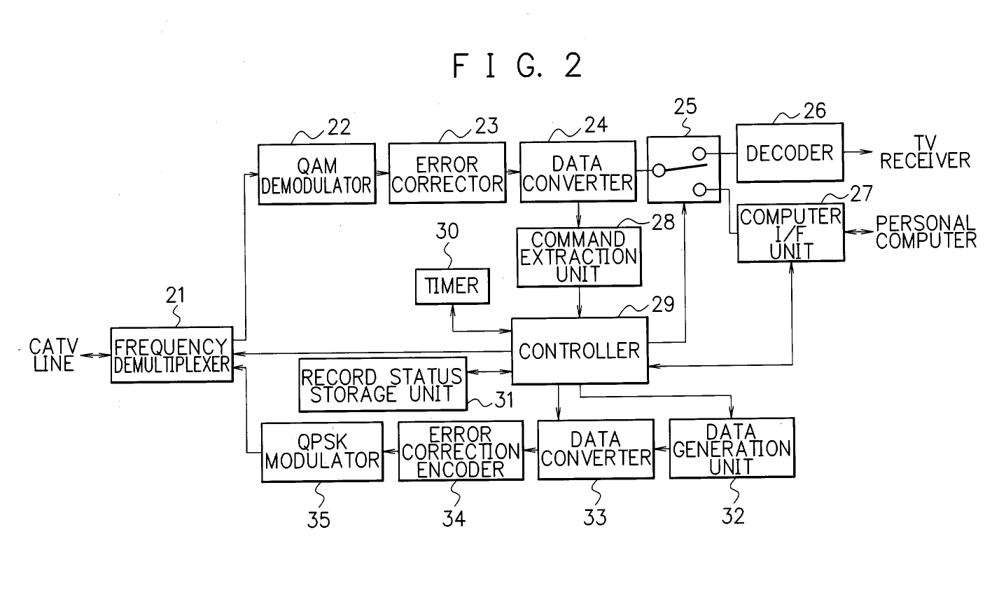

FIG. 2 shows an example of a configuration of the central portion of the cable modem 8 provided at home of each user. The cable modem 8 corresponds to the data transmitter of the present invention, and performs a downstream data process of outputting the downstream data transmitted from the CATV line 7 to the personal computer 9 and the TV receiver 10, and an upstream data process of transmitting the upstream data provided by the personal computer 9 or the upstream data generated in the cable modem 8 to the CATV line 7.

In FIG. 2, a frequency demultiplexer 21 performs a process of converting the frequency of an input signal into a desired frequency corresponding to an arbitrary channel selected from among a plurality of channels. By the user selecting a desired channel, the user can enjoy a desired television program. A QAM demodulator 22 QAM-demodulates a QAM (quadrature amplitude modulation) modulation signal input from the frequency demultiplexer 21.

An error corrector 23 performs an error correcting process based on the QAM modulation on the demodulated data output from the QAM demodulator 22. A data converter 24 performs a data converting process on a CATV transmission packet data after error correction output from the error corrector 23, and converts the data into a packet data into a format which can be processed by the personal computer 9 and the TV receiver 10. Furthermore, the data converter 24 demultiplexes the converted packet data into video data, audio data, computer data, etc. Each piece of the various demultiplexed data is output to a decoder 26 or a computer I/F unit 27 through a switch 25, and provided for the TV receiver 10 or the personal computer 9.

The above-mentioned switch 25 is controlled by a controller 29 comprising a microprocessor, etc. In this case, the switch 25 is controlled such that the computer data can be provided for the personal computer 9 through the computer I/F unit 27. On the other hand, the switch 25 is controlled such that video data and audio data can be provided for the TV receiver 10 through the decoder 26, or for the personal computer 9 through the computer I/F unit 27. The video data and the audio data provided for the personal computer 9 is accumulated on the hard disk 11, for example.

The decoder 26 decodes the video data and audio data provided by the data converter 24 through the switch 25. Normally, since video data and audio data are coded in accordance with the MPEG (moving picture coding experts group) standard, the data is decoded and converted into a data format which can be output to the display device and the speaker of the TV receiver 10.

Furthermore, the computer I/F unit 27 communicates computer data with the personal computer 9. For example, it receives, for example, connection request data transmitted from the personal computer 9 for transmission to Internet 5, digital contents distribution request data, program record request data to the hard disk 11, etc., and outputs the data to the controller 29. Furthermore, it outputs video data and audio data of a television program provided by the data converter 24 through the switch 25, or digital data such as digital contents, etc. to the personal computer 9.

A command extraction unit 28 analyzes the contents described in the electronic mail demultiplexed as computer data by the data converter 24, and extracts each type of command such as a recording start command, a recording stop command, a recording reserve command, a recording status confirm command, etc. on the hard disk 11, and outputs the extracted commands to the controller 29.

The controller 29 controls the entire cable modem 8. Especially, according to the present embodiment, the internal circuit of the cable modem 8 and the personal computer 9 are controlled according to the command provided by the command extraction unit 28.

For example, if an extracted command is a recording start command, then the switch 25 is switched to the computer I/F unit 27 side and the frequency demultiplexer 21 is controlled for a recording request channel. Then, by transmitting a control signal to the personal computer 9, the received television program can be controlled to be recorded on the hard disk 11 of the personal computer 9. At this time, the controller 29 stores the information indicating the state of “currently being recorded” in a record status storage unit 31.

If an extracted command is a recording stop command, the switch 25 is switched to the decoder 26 side, and the frequency demultiplexer 21 is controlled for a recording request channel. Then, by transmitting a control signal to the personal computer 9, the operation of recording a television program on the hard disk 11 can be controlled to stop. At this time, the controller 29 records the information indicating the status of “no recording yet” in the record status storage unit 31.

If the extracted command is a recording reserve command, then the information such as a recording starting time, a recording stop time, a desired recording channel, etc. is recorded in the record status storage unit 31. Then, the recording starting time and the recording stop time are monitored using a timer 30. When the recording starting time is reached, the switch 25 is switched to the computer I/F unit 27 side, and the frequency demultiplexer 21 is controlled to record a received television program of a desired channel for the recording on the hard disk 11 of the personal computer 9. When the recording stop time is reached, the switch 25 is switched to the decoder 26 side so that the operation of recording a television program on the hard disk 11 can be stopped.

Furthermore, when an extracted command a recording status confirm command, the information about the recording status stored in the record status storage unit 31 is retrieved, and controlled to be transmitted to the CATV line 7. When the recording status confirm request indicates confirming the current recording condition by its command, the information stored in the record status storage unit 31 is to be transmitted to the CATV line 7. On the other hand, if a command to confirm the remaining storage capacity of the hard disk 11 is received, then the controller 29 inquires of the personal computer 9 through the computer I/F unit 27, causing the obtained information to be transmitted to the CATV line 7.

Note that, the controller 29 can independently inquire of the personal computer 9 about the remaining storage capacity of the hard disk 11 regardless of the reception of a command, and record the obtained information in the record status storage unit 31, thereby immediately reading the corresponding information from the record status storage unit 31 for transmission to the CATV line 7 without inquiring of the personal computer 9 when a command to request to confirm the remaining storage capacity of the hard disk 11 is received.

A data generation unit 32 periodically or irregularly generates electronic mail acquisition request data based on the control by the controller 29. The data generation unit 32 also performs a process of generating reply data as a reply message in response to a remote operation command such as a television program recording start command, recording stop command, recording reserve command, recording status confirm command, etc. received by the controller 29. When the electronic mail acquisition request data is periodically generated, the time interval can be optionally set by the user.

A data converter 33 performs a data converting process on electronic mail acquisition request data and reply data generated by the data generation unit 32, connection request data to Internet 5 transmitted from the personal computer 9 to the controller 29 through the computer I/F unit 27, distribution request data of digital contents, program recording request data to the hard disk 11, recording status data read from the record status storage unit 31, and converts them into a transmission packet for the CATV line 7. When CATV packet data is generated from the data above, the address of its cable modem 8 is included in the packet as a source address.

An error correction encoder 34 performs an error correction encoding process based on the QPSK (quadrature phase shift keying) modulation on the CATV packet data generated by the data converter 33. That is, the error correction encoder 34 adds an error correction check bit to the CATV packet data generated by the data converter 33. A QPSK modulator 35 QPSK-modulates the CATV packet data assigned a check bit by the error correction encoder 34, and transmits the converted data to the CATV line 7 through the frequency demultiplexer 21.

Then, the operation performed when the recording on the hard disk 11, recording reservation, recording status confirmation are remotely controlled are described below by referring to FIG. 2.

When a remote operation is to be performed from anywhere the user is located etc., electronic mail describing the contents of a desired remote operation is transmitted from an Internet-capable mobile telephone, etc. The electronic mail transmitted to Internet 5 is temporarily accumulated and managed in the mail server 4 through the router 2 shown in FIG. 1.

The mail server 4 periodically or irregularly receives electronic mail acquisition request data from the cable modem 8 through the center device 1. That is, based on the control of the controller 29, the data generation unit 32 periodically or irregularly generates electronic mail acquisition request data, and the data is transmitted to the CATV line 7 through the data converter 33 the error correction encoder 34, the QPSK modulator 35, and the frequency demultiplexer 21. Then, the electronic mail acquisition request data is provided for the mail server 4 through the center device 1.

When the mail server 4 receives electronic mail acquisition request data from the cable modem 8, the electronic mail addressed to the corresponding cable modem 8 is returned. The electronic mail transmitted from the mail server 4 to the cable modem 8 through the center device 1 and the CATV line 7 is received by the frequency demultiplexer 21. Then, the electronic mail is provided for the command extraction unit 28 through the QAM demodulator 22, the error corrector 23, and the data converter 24, the contents are analyzed, and a command for remote control is extracted.

The controller 29 controls the internal circuit of the cable modem 8 according to the command extracted by the command extraction unit 28, controls the personal computer 9 by outputting a control signal through the computer I/F unit 27, and performs a process according to the command. For example, it performs a recording starting process, a recording stopping process, a recording reserving process, or a recording status data transmitting process is performed on a television program using the hard disk 11.

At this time, the controller 29 records the current recording status (whether data is being recorded, a recording reservation is made, etc.) in the record status storage unit 31 when the command extracted by the command extraction unit 28 is a recording start, recording stop, or recording reserve command. The electronic mail describing the acceptance of recording start, recording stop, or recording reserve is generated by the data generation unit 32, and transmitted to the CATV line 7 through the data converter 33, the error correction encoder 34, the QPSK modulator 35, and the frequency demultiplexer 21. The reply electronic mail transmitted to the CATV line 7 is transmitted to the mobile telephone, etc. of the remote operator through the center device 1 and the router 2.

When the command extracted by the command extraction unit 28 is a recording status confirm command, the controller 29 retrieves the information about the recording status stored in the record status storage unit 31. The retrieved recording status data is transmitted as electronic mail to the CATV line 7 through the data converter 33, the error correction encoder 34, the QPSK modulator 35, and the frequency demultiplexer 21. Then, the electronic mail transmitted to the CATV line 7 is transmitted to the mobile telephone, etc. of the remote operator through the center device 1 and the router 2.

As described above in detail, according to the present embodiment, a cable television program can be remotely controlled for the recording, recording reservation, etc. from anywhere the user is located using an Internet-capable mobile telephone and mobile information terminal in the bidirectional CATV system in which Internet 5 can be constantly connected. Thus, although the user goes out without setting the recording reservation, a record instruction can be easily issued from anywhere the user is located without fail in recording an important program, etc.

Furthermore, according to the present embodiment, the recording status can be confirmed by the user from anywhere the user is located using an Internet-capable mobile telephone and mobile information terminal. Thus, a user can confirm from where the user is located as to whether or not the recording reservation is correctly made. Furthermore, when a program is recorded or a recording reservation is made from where the user is located, the appropriate recording reservation can be made without overwriting video data on the already recorded data by confirming the remaining storage capacity of the hard disk 11.

Note that, according to the present embodiment, a remote operation instruction can be issued by electronic mail, and the cable modem 8 periodically or irregularly accesses the mail server 4, thereby obtaining the electronic mail addressed to the cable modem 8. However, the present invention is not limited to this example.

For example, the electronic mail transmitted to the mail server 4 through the router 2 over the Internet 5 can be transmitted from the center device 1 to the CATV line 7 regardless of the request from the cable modem 8. The electronic mail can be fetched only when the cable modem 8 connected to the CATV line 7 compares the destination address of the electronic mail and its own address, and the matching result is obtained. In this case, the time lag can be shortened from the transmission of the electronic mail in the remote operation to the operation performed by the cable modem 8 based on the contents of the mail.

Additionally, the home telephone device is connected to the personal computer 9, the electronic mail describing the contents of the remote operation is transmitted to the mail server 4 over the Internet 5, the user makes a phone call to the home telephone device via the telephone line, and a predetermined tone signal etc. is transmitted. The personal computer 9 can fetch the electronic mail on the mail server 4 upon receipt of a predetermined tone signal by the home telephone device as a trigger. In this case, the time lag can be shortened from the transmission of the electronic mail in the remote operation to the operation performed by the cable modem 8 based on the contents of the mail.

According to the above-mentioned embodiment, the personal computer 9 is provided with the hard disk 11 as a built-in device or an external device, but a hard disk can be built in the cable modem 8 to accumulate television programs and digital contents on the hard disk. In this case, the television programs accumulated on the hard disk in the cable modem 8 can be transmitted to the TV receiver 10 after playback at any time so that they can be enjoyed on the TV receiver 10. Furthermore, a hard disk can be built in the TV receiver 10 to accumulate television programs on the hard disk.

Additionally, in the above-mentioned embodiment, the recording start, recording stop, recording reservation, and recording status confirmation of a television program are described as the contents of remote control, but the present invention is not limited to these applications. That is, other operations relating to the recording and playback of video and audio can also be further remotely controlled, and the distribution of digital contents can be remotely controlled.

Furthermore, in the above-mentioned embodiment, a remote control is issued by electronic mail. However, it is obvious that the present invention is not limited to this appropriate. For example, a Web server may be connected to the center device 1, and the remote control instruction contents can be transmitted to the Web server using a Web browser provided for an Internet-capable mobile telephone and mobile information terminal. In this case, the remote control instruction data received by the Web server is transmitted by the center device 1 to the CATV line 7. Then, the cable modem 8 connected to the CATV line 7 compares the destination address assigned to the instruction data with its own address, and fetches the instruction data only when a matching result is output.

Additionally, in the above-mentioned embodiment, the reply data corresponding to the command is generated in the cable modem 8, but it can also be generated in the personal computer 9.

Furthermore, in the above-mentioned embodiment, the data transmission system according to the present invention is applied to a bidirectional CATV system, but it can be applied to a system other than the CATV system. That is, the present invention can be applied to any system which has the function of transmitting/receiving data and can be connected to Internet 5.

According to the above-mentioned embodiment, the hard disk 11 is used as a storage medium for accumulating television programs and digital contents, but other storage media having a large storage capacity can be used. For example, a compact disk (CD), an optical disk, a magneto-optical disk, a DVD, etc. can also be used.

The data transmission system and the data transmitter of the above-mentioned present embodiment can be configured by a CPU of a computer, or an MPU, RAM, ROM, etc., and can be realized by operating the program stored in the RAM and ROM. Therefore, a program operating to direct the computer to perform the above-mentioned functions-can be recorded in a storage medium such as CD-ROM, etc. and read by a computer to realize the system and apparatus. A storage medium for storing the above-mentioned program can be, in addition to CD-ROM, a floppy disk, a hard disk, a magnetic tape, a magneto-optical disk, a nonvolatile memory card, etc.

Furthermore, not only the functions of the above-mentioned embodiment can be realized by the computer executing the provided program, but also the functions of the above-mentioned embodiment can be realized by the program cooperating with the OS (operating system) operating in the computer, other application software, etc., and the functions of the above-mentioned embodiment can also be realized by performing all or a part of the provided program by an extension board or an extension unit of a computer. Thus, the program can be included in the embodiment of the present invention.

Furthermore, to use the present invention in a network environment, all or a part of a program can be executed by another computer.

The embodiment described above is merely an exemplary embodiment for implementation of the present invention, and should not be deemed as limitation of the scope of the invention. Thus, the present invention can be implemented in various ways without departing from the spirit and the essential features of it.

[Industrial Applicability]

The present invention is useful in improving the user convenience in a bidirectional CATV service by remotely operating the recording of a television program using CATV and distributing digital contents by the user from anywhere the user is located.

What is claimed is:

1-8. (delete)

9. A data transmission system having a center device and one or more data transmitters connected to the center device through a transmission line, comprising:
a data recording medium for accumulating and storing data transmitted from the center device to the data transmitter through the transmission line;
control means for receiving electronic mail, which is including desired instruction contents transmitted to the center device, by the data transmitter through the transmission line, analyzing contents of the electronic mail, and performing a controlling process to perform a process specified by the electronic mail; and
a mail server for accumulating and managing the electronic mail transmitted to the center device, characterized in that
the data transmitter issues a mail acquisition request to the mail server using a predetermined tone signal received through a telephone line as a trigger, thereby receiving the electronic mail by the data transmitter through the transmission line.

10-19. (delete)

20. A data transmitter connected to a center device through a transmission line, comprising:
control means for receiving electronic mail including desired instruction contents transmitted to the center device through the transmission line, and performing a controlling process to accumulate and store data transmitted from the center device through the transmission line in a data recording medium depending on contents of the electronic mail, characterized in that
the electronic mail is received through the transmission line by issuing a mail acquisition request to a mail server using a predetermined tone signal received through a telephone line as a trigger.

21-26. (delete)

27. A remote control method for use with a data transmission system having a center device and one or more data transmitters connected to the center device through a transmission line, comprising:
transmitting electronic mail including desired instruction contents to the center device, further transmitting the electronic mail from the center device to the data transmitter through the transmission line, and analyzing contents of the electronic mail received by the data transmitter, thereby performing a process specified by the electronic mail;
accumulating and managing the electronic mail transmitted to the center device by a mail server; and
receiving the electronic mail by the data transmitter through the transmission line by issuing a mail acquisition request to the mail server by the data transmitter using a predetermined tone signal received through a telephone line as a trigger.
